(19) United States
(12) Patent Application Publication
(10) Pub. No.: US 2011/0253943 A1
(43) Pub. Date: Oct. 20, 2011

(54) ONE PART EPOXY RESIN INCLUDING A LOW PROFILE ADDITIVE

(75) Inventors: Rong-Chang Liang, Cupertino, CA (US); Yuhao Sun, Fremont, CA (US); Hua Song, Fremont, CA (US); Chin-Jen Tseng, Fremont, CA (US); Hsiao Ken Chuang, Sunnyvale, CA (US)

(73) Assignee: TRILLION SCIENCE, INC., Fremont, CA (US)

(21) Appl. No.: 12/762,623

(22) Filed: Apr. 19, 2010

(51) Int. Cl. H01B 1/12; C09J 163/00

(52) U.S. Cl. 252/500; 523/436

(57) ABSTRACT

An adhesive composition comprising: (i) a one part curable epoxy adhesive and (ii) a low profile additive (LPA), the low profile additive being a polymer that is compatible with the epoxy adhesive such that it forms a single phase when admixed with the adhesive composition and that separates from the adhesive to form a network of stress-absorbing nodules therein when the adhesive is cured, the low profile additive being present in an amount sufficient to prevent or reduce shrinkage and/or the formation of voids or cracks when the adhesive is cured. In one embodiment the LPA is a block copolymer including at least one flexible block and at least one rigid block that makes the low profile additive compatible with the epoxy adhesive such that a mixture of the uncured epoxy resin and the low profile additive forms a homogenous solution and as the epoxy resin is cured, the low profile additive forms a stress absorbing network of nodules in the cured epoxy resin matrix.

### BACKGROUND OF THE INVENTION

1. Field of the Invention

The invention relates to epoxy adhesive or molding compound compositions suitable for connecting, assembling, encapsulating or packaging electronic devices particularly for display, circuit board, flip chip and other semiconductor devices containing a low profile additive. This invention particularly relates to one-part epoxy compositions containing a low profile additive that resist the formation of micro-cracks or micro-voids formed by shrinkage of the composition during curing. More specifically, application of this epoxy relates to adhesives for an anisotropic conductive film (ACF) to adhesively bond two electric terminals with good electroconductivity.

2. Description of the Related Art

Epoxy systems, one part epoxy systems in particular, have the advantages of convenient applications as adhesives or molding compounds for connecting, assembling, encapsulating or packaging electronic devices, for adhesive or molding compound applications, epoxies are considered to be superior to the thermoplastic adhesives because of the process-ability of the uncured composition and the heat resistance of the cured products. Furthermore, among the epoxy applications, the one-part epoxy systems are in general more preferred than the two-part systems for most of the molding compounds and pre-coated products including anisotropic conductive adhesive films (ACFs or ACAFs). This is because the one-part systems are much more user friendly between these two systems.

Although epoxy adhesive compositions exhibit a number of advantages including good strength and high adhesion, they suffer certain drawbacks. In particular, they shrink upon curing and this shrinkage causes the formation of micro-voids or micro-cracks. This shrinkage is associated with two occurrences: (1) thermal contraction when the heated bonding element is removed and the compound cools, and (2) volume shrinkage resulting from the tight network that is developed upon physical and chemical crosslinking of the compound. These cracks and voids reduce the mechanical strength of the adhesive bond and they also make the compound susceptible to moisture such that the bonded electronic component may fail when subjected to high temperature and high humidity aging (HHHT).

### SUMMARY OF THE INVENTION

The one-part epoxy system typically includes an uncured epoxy resin component, a curing agent and/or an accelerator and a low profile additive (LPA) that is miscible with the epoxy resin and which separates to form a network of stress-absorbing nodules upon curing the epoxy resin. In one embodiment the LPA is a block copolymer including at least one flexible mid block and, more particularly, an elastomeric mid block; and at least one rigid block that renders the LPA compatible with the uncured epoxy resin.

The improved epoxy composition as will be further described below in one embodiment may be implemented in an exemplary embodiment as conductive coating or adhesive for an anisotropic conductive film (ACF) and, in a particular embodiment in the ACF described in U.S. Published Application 2006/0280912 to Liang et al. The ACF includes a plurality of conductive particles disposed at predetermined locations in an adhesive layer between a bottom and top substrates. The improved epoxy composition may further be employed as a conductive coating or adhesive for connecting, packaging or encapsulating electronic components in another exemplary embodiment similar to the application of the adhesive described in U.S. Published Application 2008/0090943. The disclosures made in the aforementioned published patent applications are hereby incorporated by reference in this patent application.

### Typical Epoxy Adhesives and Molding Compounds

The epoxy resin component includes at least one epoxy resin that has two or more epoxy groups in a single molecule. The curing agent initiates and/or accelerates the reaction by either catalyzing and/or taking part in the reaction. Preferably, the accelerator component and the other epoxy adhesive components are selected such that the epoxy adhesive is very stable at the storage conditions but cures rapidly at the bonding temperature. Reviews of epoxy crosslinking systems may be found in, for example, J. K. Fink, “Reactive Polymers, Fundamentals and Applications,” William Andrew Publishing, NY (2005); J. A. Brydson, “Plastic Materials,” Ch. 26, 7th ed., Butterworth-Heinemann (1999); C. D. Wright and J. M. Muggee in S. R. Hartshorn, ed., “Structure Adhesives,” Ch. 3, Plenum Press, NY (1986); and H. Lee, “The Epoxy Resin Handbook,” McGraw-Hill, Inc., NY (1981).

Typical examples of epoxides or epoxy resins used in adhesives or molding compounds include polyglycidyl ethers of polyhydric phenols such as bisphenol epoxy resins derived from epichlorohydrin and bisphenol A or bisphenol F, and epoxy novolak resins derived from epichlorohydrin and phenol novolak or cresol novolak resins (e.g., Epon 161 and Epon 165 available from available from Hexion Specialty Chemicals). Other examples include polyglycidyl esters of polycarboxylic acids, alicyclic epoxy compounds, polyglycidyl ethers of polyhydric alcohols, and polyglycidyl compounds of polyvalent amines. These compounds may be partly modified in the structure, e.g., with urethane, nitrile rubber or silicone. Additional examples of suitable epoxy resins are found in, for example: J. K. Fink, “Reactive Polymers, Fundamentals and Applications,” William Andrew Publishing, NY (2005); J. A. Brydson, “Plastic Materials,” Ch. 26, 7th ed., Butterworth-Heinemann (1999); H. Lee, “The Epoxy Resin Handbook,” McGraw-Hill, Inc., NY (1981); and C. D. Wright and J. M. Muggee in S. R. Hartshorn, ed., “Structure Adhesives,” Ch. 3, Plenum Press, NY (1986). In addition to the epoxy resin, the adhesive may also contain an epoxy binder such as Paphen phenoxy resin (PKHH) from Phenoxy Specialties or PKFE from Inchemrez (U.S.A). The binder may be used in amounts of about 15 to 35 wt. % and more particularly about 25 to 30 wt. %. In one embodiment, the epoxy resin is derived from Epon 161, Epon 165, Bisphenol A and Bisphenol F, and PKHH (polyhydroxy ether phenoxy resin). In another embodiment, the resin is derived from Epon 161, Epon 165, Bisphenol F and PKFE.

Examples of epoxy resins and compositions used herein are provided below.

Epoxy composition 1

| | Parts |
|---|---|
| Ingredient | (dry) |
| Bis-A epoxy (YL980U) | 5.35 |
| Bis-F epoxy (YL983U) | 16.37 |
| Epon 161 | 6.22 |
| Epon 165 | 3.11 |
| PKHH | 22.89 |

Epoxy composition 2

| | Parts |
|---|---|
| Ingredient | (dry) |
| Bis-A epoxy (YL980U) | 4.92 |
| Bis-F epoxy (YL983U) | 15.04 |
| Epon 161 | 5.72 |
| Epon 165 | 2.86 |
| PKHH | 24.14 |

Epoxy composition 3

| | Parts |
|---|---|
| Ingredient | (dry) |
| Bis-A epoxy (YL980U) | 4.84 |
| Bis-F epoxy (YL983U) | 14.81 |
| Epon 161 | 5.63 |
| Epon 165 | 2.81 |
| PKHH | 23.76 |

Epoxy composition 4

| | Parts |
|---|---|
| Ingredient | (dry) |
| Bis-F epoxy (YL983U) | 12.88 |
| Epon 161 | 6.10 |
| Epon 165 | 3.05 |
| PKHH | 25.76 |

Epoxy composition 5

| | Parts |
|---|---|
| Ingredient | (dry) |
| Bis-F epoxy (YL983U) | 12.50 |
| Epon 1009F | 6.00 |
| PKHH | 25.00 |

Epoxy composition 6

| | Parts |
|---|---|
| Ingredient | (dry) |
| Bis-A epoxy (YL980U) | 6.00 |
| Bis-F epoxy (YL983U) | 7.60 |
| Epon 161 | 6.40 |
| Epon 165 | 3.30 |
| PKHH | 19.20 |

Epoxy composition 7

| | Parts |
|---|---|
| Ingredient | (dry) |
| Bis-F epoxy | 8.00 |
| Epon 161 | 5.00 |
| Epon 165 | 3.00 |
| PKFE | 31.00 |

The curing agents or accelerators typically used in epoxy adhesives or molding compounds include polyamide-polyamine-based compounds, aromatic polyamine compounds, imidazole compounds, tetrahydrophthalic anhydride and the like. The accelerator or curing agent may be liquid or solid. Preferred liquid accelerators include, e.g., amine compounds, imidazole compounds and mixtures thereof. Exemplary liquid accelerator compounds include 1-(2-hydroxyethyl)imidazole, 2-methylimidazole, 2-ethyl-4-methylimidazole, 1-benzyl-2-methylimidizole, 1-cyanoethyl-2-phenyl-4, 5-dihydroxymethyl imidazole, 1-(2-hydroxyethyl)imidazole, 2-ethyl-4-methylimidazole, phenylimidazole, 2-phenyl-4-methylimidazole, 1-cyanoethyl-2-phenylimidazole, multifunctional mercaptans (e.g., Anchor 2031), and stannous octate. Preferred solid accelerators include, e.g., urea, 2-phenyl-4,5-dihydroxymethyl imidazole, and 1-(2-hydroxyethyl)imidazole. Other examples of curing agents include dicyanodiamide (DICY), adipic dihydrazide, amines such as ethylene diamine, diethylene triamine, triethylene tetraamine, BF3 amine adduct, Amicure from Ajinomoto Co., Inc, sulfonium salts such as diaminodiphenylsulphone, p-hydroxyphenyl benzyl methyl, and sulphonium hexafluoroantimonate. For shelf stability in applications that require high speed curing at low temperature curing catalysts/accelerators may optionally be absorbed in a molecular sieve or in the form of microcapsules to enhance the curing processes as disclosed in Japanese Patent Publication No. 17654/68, 64/70523, U.S. Pat. Nos. 4,833,226, 5,001,542, 6,936,644. In the case of microencapsulated accelerators or curing agents, the microcapsules must be first broken or rendered permeable by pressure, shear, heat or combinations of above methods in order to cure the epoxy resin. Examples of commercially available imidazole microcapsules include the Novacure series from Asahi Chemical Industry Co., Ltd. such as HX 3721 (2-methyl imidazole). However, in most cases, the stability is improved at the expense of curing speed. The preferable concentration range of the latent catalyst/curing agent is from about 0.05% by weight to about 50% by weight, more preferably from about 2% by weight to about 40% by weight based on the adhesive composition. In the case when a microencapsulated latent curing agent such as Novacure imidazole microcapsule is used, the more preferable concentration range is from about 5% by weight to about 40% by weight and still more particularly about 25 to 40% by weight based on the adhesive composition.

To further improve the curing characteristics, a group of secondary co-catalyst or co-curing agent is also disclosed. As disclosed in Published Application 2008/0090943, it was found that significant improvements in reaction kinetics could be achieved by incorporating in the epoxy composition about 0.01% to about 8%, more preferably about 0.05% to 5%, by weight of a secondary co-catalyst or co-curing agent selected from a group consisting of ureas, urethans, biurets, allophanates, amides and lactams comprising a N N,N-dialkylamino, N,N-diarylamino, N-alkyl-N-aryl-amino or a dicycloalkylamino functional group. Useful examples include amide such as N-(3-(dimethyamino)propyl)lauramide, lactams such as 1,2-benzisothiazol-3(2H)-one, and benzothiazols such as 2-(2-benzothiazolylthio)ethanol. To further improve the connection reliability and consistency of the curing kinetics, less diffusive derivatives, dimers or oligomers of the above mentioned co-catalysts have been found particularly useful. Not to be bound by the theory, it was believed that the increasing molecular weight or improving its compatibility with the epoxide resin can effectively reduce the mobility of the co-catalyst to migrate out of the adhesive film during aging and resulted in a better environmental stability.

U.S. Published Application 2008/0090943 discloses that leuco dyes, particularly those comprising a N,N-dialkylamino, N,N-diarylamino, N-alkyl-N-aryl-amino, N-alkylamino, or N-arylamino functional group on at least one of their aromatic rings, function as very effective co-catalysts or co-accelerators to improve the curing characteristics of epoxy resins. More specifically, it discloses adhesive compositions comprising a leuco dye and a latent curing agent such as Novacure imidazole capsules. The leuco dyes have shown significant improvement in curing and conversion of the epoxides while maintaining acceptable shelf-life stability. The concentration of the leuco dye used is from about 0.05% by weight to about 15% by weight, preferably from about 0.5% by weight to about 5% by weight based on the total weight of the adhesive composition.

Suitable cocatalysts of the present invention include, but are not limited to, triarylmethane lactones, triarylmethane lactams, triarymethane sultones, fluorans, phthalides, azaphthalides, spiropyrans, spirofluorene phthalides, spirobenzantharacene phthalides. Leuco dyes comprising a N,N-dialkylamino, N,N-diarylamino, N,N-dialkylaryl or N-alkyl-N-aryl-amino, N-alkylamino, or N-arylamino group on the aromatic ring are particularly useful.

In one embodiment, the LPAs can be diblock (A-B), triblock (A-B-A) or a multiblock (A-(B-A)n) where n is from 2 to 8 block copolymers that include a flexible elastomeric midblock. In accordance with one embodiment, the flexible (B) midblock is a poly alkyl (meth)acrylate wherein the alkyl group contains about 2 to 8 carbon atoms such as polybutyl acrylate, polyethyl acrylate, poly 2-ethylhexyl acrylate, poly(2-ethylhexyl) methacrylate and poly (isooctyl acrylate). Polyether polyurethanes are also useful as flexible blocks. In another embodiment the flexible mid block is a carboxyl terminated butadiene acrylonitrile (CTBN) rubber. In still another embodiment, the LPA is a block copolymer in which a poly(butyl acrylate) is positioned between two poly(methyl methacrylate) mid blocks.

Examples of block copolymers that may be effective LPAs include those shown in the following table:

| | Description | EEW(g/eq) |
|---|---|---|
| Epon 58003 | An elastomer modified epoxy functional | 285-330 |
| (Hexion | adduct of a bisphenol-F epoxy resin and | |
| Specialty | a carboxy-terminated butadiene-acrylonitrile | |
| Chemicals) | (CTBN) rubber. Elastomer content 40%. | |
| Epon 58005 | An elastomer modified epoxy functional | 325-375 |
| (Hexion | adduct of bisphenol A epoxy resin and a | |
| Specialty | carboxyl terminated butadiene-acrylonitrile | |
| Chemicals) | (CTBN) elastomer. Elastomer content 40%. | |
| Epon 58034 | An elastomer modified epoxy functional | 275-305 |
| (Hexion | adduct formed from the reaction of | |
| Specialty | HELOXY ™ 68 Modifier and a carboxyl | |
| Chemicals) | terminated butadiene-acrylonitrile elastomer. | |
| | HELOXY ™ Modifier 68 is a diglycidyl | |
| | ether of neopentyl glycol. Elastomer content | |
| | is approximately 50 percent by weight. | |
| HyPox RK84 | Adduct of solid diglycidyl ether of | 1200-1800 |
| (CVC | Bisphenol A and a CTBN rubber. Elastomer | |
| Thermoset | content 55%. | |
| Specialties) | | |
| HyPox RK84L | Adduct of solid diglycidyl ether of | 1250-1500 |
| (CVC | Bisphenol A and a CTBN rubber. Elastomer | |
| Thermoset | content 55%. | |
| Specialties) | | |
| HyPox UA10 | A standard Bisphenol A epoxy resin which | 210-220 |
| (CVC | has been modified with a select | |
| Thermoset | thermoplastic polyurethane (TPU). | |
| Specialties) | Elastomer content 12%. | |
| HyPox UA11 | A standard Bisphenol A epoxy resin system | 210-220 |
| (CVC | which has been modified with a select | |
| Thermoset | thermoplastic polyurethane (TPU). Urethane | |
| Specialties) | polymer content 5%. | |
| M51 | A symmetric MAM copolymer with two | — |
| (Arkema, | poly(methyl methacrylate) blocks | |
| Inc.) | surrounding a center block of poly(butyl | |
| | acrylate). Low MW, lowest viscosity. | |
| M52 | A symmetric MAM copolymer with two | — |
| (Arkema, | poly(methyl methacrylate) blocks | |
| Inc.) | surrounding a center block of poly(butyl | |
| | acrylate). Low MW, lowest viscosity. | |
| | Medium MW, low viscosity. | |
| M53 | A symmetric MAM copolymer with two | — |
| (Arkema, | poly(methyl methacrylate) blocks | |
| Inc.) | surrounding a center block of poly(butyl | |
| | acrylate). High MW, best toughening with | |
| | PMMA friendly crosslinking agents (e.g., | |
| | Jeffamine, MDEA) | |
| M52N | A symmetric MAM copolymer with two | — |
| (Arkema, | poly(methyl methacrylate) blocks | |
| Inc.) | surrounding a center block of poly(butyl | |
| | acrylate). Functionalized MAM, best | |
| | toughening with PMMA unfriendly | |
| | crosslinking agents (e.g., DICY, DDS). | |

In another embodiment, the LPA is not necessarily a block copolymer, but a polymer that is miscible with the epoxy resin and separates to form stress-absorbing nodules upon curing.

One example of a rigid polymer block is poly (methyl methacrylate). In addition to being rigid, this block is also compatible with the epoxy resin, such that the LPA can be mixed with the uncured resin without phase separation when the LPA is used in amounts effective to prevent shrinkage. In accordance with one embodiment, the (A) and (B) blocks of the LPA are selected such that the LPA and the epoxy resin form a homogeneous solution when the LPA is used in amounts up to 15% by weight. M52N from Arkema, Inc. is a particularly useful LPA.

In another embodiment, the LPA is not necessarily a block copolymer, but a polymer that is miscible with the epoxy resin and separates to form stress-absorbing nodules upon curing. Other examples of LPAs are conjugated dienes having about 4 to 12 carbon atoms with polybutadiene and polyisoprene being two representative examples, provided they are compatible with the epoxy resin. In accordance with one modification, the compatibility of the LPA in the epoxy adhesive can be enhanced by epoxidizing the block copolymer as described in U.S. Pat. No. 5,428,105. For example, if the LPA copolymer includes unsaturated groups such as an unsaturated diene, a portion of these groups (e.g., about 1 to 15%) can be oxidized.

The LPA may be used in amounts up to about 15% by weight based on the combined weight of the LPA and the epoxy resin. The LPA is more typically used in an amount of about 4 to 10% and in one embodiment it is used in an amount of about 7%. The amount of the LPA is adjusted to provide the required peeling strength.

The molecular weight (Mw) of the LPA may be about 15,000 to 200,000 and more typically about 50,000 to 100,000. In one embodiment, the molecular weight (Mw) is about 88,000. In one embodiment, the LPA contains about 5 to 50% of the flexible (B) block.

The LPA when mixed with the uncured epoxy resin forms a homogenous single phase. As the epoxy resin cures, the epoxy resin network is formed which phase separates from the initial solution and forms spherical nodules of the LPA. This is called “reaction induced phase separation.” The size of the stress absorbing nodules will vary with the amount of LPA used, the Mw of the LPA and the interaction between the epoxy resin and the LPA. In certain embodiments, ultimately a network is formed wherein the LPA nodules are connected to adjacent nodules by a polymer link. As the epoxy resin cures and begins to shrink, cracking is prevented because the stresses are transferred to the nodular LPA phase which is flexible. The disclosed block copolymers have been found to be particularly effective.

The epoxy adhesive may comprise a filler or additive to control one or more properties of the epoxy adhesive such as rheology, wetting and moisture resistance. A particulate rheology modifier may be added to the epoxy adhesive. The rheology modifier may be a thixotropic agent having an average particle size between about 0.001 and about 10 microns, and more preferably between about 0.01 and about 5 microns. Examples of particulate rheology modifiers include barium sulfate, talc, aluminum oxide, antimony oxide, kaolin, finely divided silicon dioxide which may be colloidal or rendered hydrophobic, micronized talcum, micronized mica, clay, kaolin, aluminum oxide, aluminum hydroxide, calcium silicate, aluminum silicate, magnesium carbonate, calcium carbonate, zirconium silicate, porcelain powder, glass powder, antimony trioxide, titanium dioxide, barium titanate, barium sulfate and mixtures thereof. One particularly preferred rheology modifier is fumed silica such as Cab—O—Sil M-5 from Cabot Corp., MA.

To improve the ability of the epoxy adhesive to wet a surface a wetting agent may be added. Exemplary wetting agents include surfactants such as epoxy silanes, branch or block copolymers of siloxanes, fluoro-surfactants and hydrocarbon-type surfactants. Suitable surfactants include FC4430 (formally referred to as FC-430) which is available from 3M Corp. of St. Paul Minn., Silwet series surfactants from GE Silicones-OSi Specialties, BYK 322, BYK325 and BYK 631N from BYK-Chemie. The Silwet surfactants are often used in an amount of about 3 to 5% by weight.

The moisture resistance of the cured compound may be improved by including a coupling agent in the epoxy adhesive. Typical coupling agents include organic metal compounds that comprise chromium, silane, titanium, aluminum and zirconium. The most commonly used coupling agents comprise silane such as vinyl-triethoxysilane, vinyltris(2-methoxyethoxy)silane, 3-methacryloxypropyltrimethoxysilane, 3-glycidoxypropyltrimethoxysilane (e.g., Silquest 187® from Crompton), 2-(3,4-epoxycyclohexyl)ethyltrimethoxy silane, N-2-(aminoethyl)-3-aminopropylmethyldimethoxy-silane, 3-aminopropyltriethoxysilane, and 3-chloro-propyltrimethoxy-silane. If present, the coupling agent frequently comprises less than about 2% by weight of the epoxy adhesive.

For prepreg, filament winding and molding compound applications, reinforcement fibers such as glass fiber and carbon fiber are often included in the composition. Natural fibers such as bamboo fibers, wood and other cellulose fibers are also useful. They may be in a pellet form prepared by extrusion followed by cutting or in a sheet form prepared by coating, lamination or impregnation.

The epoxy compositions of this invention may be applied in a conductive coating or adhesive layer or layers, the conductive particles either in the random or non-random arrays may be in the adhesive layer, on the adhesive layer or underneath the adhesive layer. Flexible configurations may be conveniently arranged according to particular application requirements. These configurations may include an arrangement where the adhesive that comprises the improved epoxy compositions of this invention and the conductive particles are disposed in separate, adjacent or non-adjacent layer in an ACF of either a random or non-random particle array.

Suitable materials for the web of an ACF include, but are not limited to polyesters such as poly ethylene terephthalate (PET) and polyethylene naphthalate (PEN), polycarbonate, polyamides, polyacrylates, polysulfone, polyethers, polyimides, and liquid crystalline polymers and their blends, composites, laminates or sandwich films. The improved ACF is disclosed in another co-pending patent application Ser. No. 11/418,414 entitled “Non-random Array of An-isotropic Conductive Film (ACF) and Manufacturing Processes”. The disclosures made in that patent application are hereby incorporated by reference in this patent application.

It is evident that the present invention provides an epoxy composition with improved curing characteristics for high speed, automatic electronic packaging or device connection applications such as bonding with an ACF. The invention is illustrated in more detail below by reference to the following non-limiting examples wherein unless otherwise limited, all parts are by weight.

The adhesive compositions can be prepared by dissolving the solid epoxy components in MEK to prepare stock solutions of each ingredient. The low molecular weight or low percentage components are mixed and vigorously blended together. Dispersions of the rheology modifier in MEK are prepared and added to the coating composition followed by addition of the high Mw components and surfactants. Before coating, the hardener is dissolved in MEK and added to the coating with agitation (5 min.) and continuous stirring rotation (0.5 hr.). The coating composition is filtered through an 11μ filter and then degassed by ultrasound for 5 min. The ingredients useful in one embodiment are identified in the following table.

| Ingredient | | |
|---|---|---|
| Bis-A epoxy | Bisphenol A epoxy resin | |
| (YL980U) | | |
| Bis-F epoxy | Bisphenol F epoxy resin | |
| (YL983U) | | |
| Epon 161 | Epoxy resin | Hexion Specialty |
| | | Chemicals |
| Epon 165 | Epoxy resin | Hexion Specialty |
| | | Chemicals |
| Epon 58003 | See Table 1 | Hexion Specialty |
| | | Chemicals |
| HyPox UA11 | See Table 1 | CVC Thermoset |
| | | Specialties |
| Milled Cab-O-Sil M5 | Fumed silica | Cabot Corp. |
| Milled nanoAlN | | |
| PKHH | Phenoxy resin | Phenoxy |
| | | Specialties |
| Novacure HX 3721 | Encapsulate 2-methyl imidazole | Asahi |
| | | Chemical Ind. |
| Reactive silwet | Organosilicone Surfactant | Setre |
| | | Chemical Co. |
| Silquest 187 | Gamma- | Crompton |
| | glycidoxyproplytrimethoxysilane | |

The following formulations are examples of particularly effective adhesive compositions:

### EXAMPLE 1

| | W % in |
|---|---|
| | dried |
| Ingredient | film |
| Bis-A epoxy (YL980U) | 6.00% |
| Bis-F epoxy (YL983U) | 7.60% |
| Epon 161 | 6.40% |
| Epon 165 | 3.30% |
| M52N | 7.50% |
| milled M5 | 0.65% |
| milled nanoA1N | 3.23% |
| PKHH | 19.20% |
| co-catalysts | 0.50% |
| HX 3721 | 30.90% |
| reactive silwet | 3.90% |
| silquest 187 | 1.20% |
| Total | 90.38% |

### EXAMPLE 2

| | Parts |
|---|---|
| Ingredient | (dry) |
| Bis-F epoxy | 8.00% |
| Epon 161 | 5.00% |
| Epon 165 | 3.00% |
| M52N | 6.03% |
| PKFE | 31.00% |
| PKCP-80 | 5.87% |
| Reactive silwet | 3.50% |
| L7608 | |
| Silquest A-187 ® | 1.00% |
| Magenta20 | 0.50% |
| HX 3721 | 34.60% |
| Total | 100.00% |

Having described the invention in detail and by reference to specific embodiments thereof it will be apparent that numerous variations and modifications are possible without departing from the spirit and scope of the following claims.

What is claimed is:

1. An adhesive composition comprising: (i) a one part curable epoxy adhesive and (ii) a low profile additive (LPA), the low profile additive being a polymer that is compatible with the epoxy adhesive such that it forms a single phase when admixed with the adhesive composition and that separates from the adhesive to form a network of stress-absorbing nodules therein when the adhesive is cured, the low profile additive being present in an amount sufficient to prevent or reduce shrinkage and/or the formation of voids or cracks when the adhesive is cured.

2. The adhesive composition of claim 1 wherein the LPA is a block copolymer having a first flexible block and a second rigid block that makes the LPA compatible with the uncured epoxy adhesive, wherein a mixture of the epoxy resin and the low profile additive forms a homogenous solution, and as the epoxy resin is cured, the low profile additive forms a network of stress absorbing nodules in the epoxy resin matrix.

3. The adhesive composition of claim 2 wherein the low profile additive has a molecular weight (Mw) of about 15,000 to 200,000.

4. The adhesive composition of claim 3 wherein the flexible block is formed from a poly(alkyl acrylate) wherein the alkyl group has about 2 to 8 carbon atoms.

5. The adhesive composition of claim 4 wherein the flexible block is formed from a polymer of a conjugated diene, or a polyether polyurethane.

6. The adhesive composition of claim 5 wherein the flexible block is formed from poly(butyl acrylate).

7. The adhesive composition of claim 6 wherein the low profile additive includes at least one rigid block that improves the compatibility of the low profile additive with the epoxy resin.

8. The adhesive composition of claim 7 wherein the LPA is a triblock including blocks of poly(methyl methacrylate) on each end of a poly(butyl acrylate) block.

9. The adhesive composition of claim 8 wherein the low profile additive is a symmetric block copolymer with two poly(methyl methacrylate) blocks surrounding a center block of poly(butyl acrylate).

10. The adhesive composition of claim 3 wherein the low profile additive is present in an amount up to about 15% by weight.

11. The adhesive composition of claim 10 wherein the rigid block polymer is poly (methyl methacrylate).

12. The adhesive composition of claim 10 wherein the low profile additive is present in the adhesive composition in amount of about 4 to 10% based on the total weight of the composition.

13. A film useful in providing an anisotropic conductive film comprising a plurality of conductive particles and an adhesive composition including a curable epoxy adhesive and a low profile additive, the adhesive composition including: (i) a one part curable epoxy adhesive and (ii) a low profile additive, the low profile additive being a polymer that is compatible with the epoxy adhesive such that it forms a single phase when admixed with the adhesive composition and that separates from the adhesive to form a network of stress-absorbing nodules therein when the adhesive is cured, the low profile additive being present in an amount sufficient to prevent or reduce shrinkage and/or the formation of voids or cracks when the adhesive is cured.

14. The film of claim 13 wherein the low profile additive is a block copolymer including at least one flexible block and at least one rigid block that makes the low profile additive compatible with the epoxy adhesive such that a mixture of the uncured epoxy resin and the low profile additive forms a homogenous solution and, as the epoxy resin is cured, the low profile additive forms a network of nodules in the cured epoxy resin matrix.

15. The film of claim 14 wherein the flexible block is formed from poly(butyl acrylate).

16. The film of claim 15 wherein the LPA is a triblock including blocks of poly(methyl methacrylate) on each end of a poly(butyl acrylate) block.

17. An electronic device having an anisotropic conductive film formed from a cured adhesive composition comprising a one part curable epoxy adhesive and a low profile additive, the low profile additive being a polymer that is compatible with the epoxy adhesive such that it forms a single phase when admixed with the adhesive composition and that separates from the adhesive to form a network of stress-absorbing nodules therein when the adhesive is cured, the low profile additive being present in an amount sufficient to prevent or reduce shrinkage and/or the formation of voids or cracks when the adhesive is cured.

18. The electronic device of claim 17 wherein the low profile additive is a block copolymer including at least one flexible block and at least one rigid block that makes the low profile additive compatible with the epoxy adhesive such that a mixture of the uncured epoxy resin and the low profile additive forms a homogenous solution and as the epoxy resin is cured, the low profile additive forms a network of nodules in the cured epoxy resin matrix.

19. The device of claim 18 wherein the flexible block is formed from poly(butyl acrylate).

20. The device of claim 19 wherein the LPA is a triblock including blocks of poly(methyl methacrylate) on each end of a poly(butyl acrylate) block.

21. The device of claim 17 wherein the device is a semiconductor.

22. The device of claim 17 wherein the device is a computer chip.
